(19) United States
(12) Patent Application Publication
(10) Pub. No.: US 2006/0024609 A1
(43) Pub. Date: Feb. 2, 2006

(54) Process for the production of negative working lithographic printing plate precursors with a coating comprising diazo resin

(75) Inventors: Udo Dwars, Herzberg am Harz (DE); Harald Baumann, Osterode am Harz (DE); Michael Mursal, Horden (DE); Axel Draber, Osterode (DE)

Correspondence Address: FAEGRE & BENSON;ATTN: PATENT DOCKING, 2200 WELLS FARGO CENTER, 90 SOUTH 7TH STREET, MINNEAPOLIS, MN, 55402-3901, US

(73) Assignee: Kodak Polychrome Graphics LLC, Norwalk, CT (US)

(21) Appl. No.: 10/537,471

(22) PCT Filed: Dec. 17, 2003
(86) PCT No.: PCT/EP03/14418

§ 371 Date: Jun. 3, 2005

(30) Foreign Application Priority Data
Dec. 19, 2002 (DE) 102 59 769.3
Jan. 20, 2003 (DE) 103 01 972.3

(51) Int. Cl. G03C 1/76

(52) U.S. Cl. 430/270.1

(57) ABSTRACT

A process for the production of lithographic printing plate precursors with a coating comprising a diazo resin is described, wherein a solvent mixture comprising (i) 2 to 9.9 wt.-% 1-methoxy-2-propanol, (ii) 20 to 50 wt.-% of at least one ketone with a boiling point below 130° C., (iii) 20 to 60 wt.-% of at least one alkanol with a boiling point below 120° C., and (iv) 10 to 30 wt.-% ethyl lactate, and a slot coater are used to produce the printing plate precursors.

The present invention relates to a process for the production of negative working printing plate precursors with a coating comprising diazo resin. The invention furthermore relates to a composition for use in this process and printing plate precursors obtained according to this process.

The technical field of lithographic printing is based on the immiscibility of oil and water, wherein the oily material or the printing ink is preferably accepted by the image area, and the water or fountain solution is preferably accepted by the non-image area. When an appropriately produced surface is moistened with water and a printing ink is applied, the background or non-image area accepts the water and repels the printing ink, while the image area accepts the printing ink and repels the water. The printing ink in the image area is then transferred to the surface of a material such as paper, fabric and the like, on which the image is to be formed. Generally, however, the printing ink is first transferred to an intermediate material, referred to as blanket, which then in turn transfers the printing ink onto the surface of the material on which the image is to be formed; this technique is referred to as offset lithography.

A frequently used type of lithographic printing plate precursor comprises a photosensitive coating applied onto a substrate on aluminum basis. The coating can react to radiation such that the exposed portion becomes so soluble that it is removed during the developing process. Such a plate is referred to as positive working. On the other hand, a plate is referred to as negative working if the exposed portion of the coating is hardened by the radiation. In both cases, the remaining image area accepts printing ink, or is oleophilic, and the non-image area (background) accepts water, or is hydrophilic. The differentiation between image and non-image areas takes place during exposure, for which a film is attached to the printing plate precursor under vacuum in order to guarantee good contact. The plate is then exposed by means of a radiation source. Alternatively, the plate an also be exposed digitally without film, e.g. by means of a UV laser. When a positive plate is used, the area on the film corresponding to the image on the plate is so opaque that the light does not reach the plate, while the area on the film corresponding to the non-image area is clear and allows light to permeate the coating, whose solubility increases. In the case of a negative plate, the opposite takes place: The area on the film corresponding to the image on the plate is clear, while the non-image area is opaque. The coating beneath the clear film area is hardened due to the incident light, while the area not affected by the light is removed during developing. The light-hardened surface of a negative working plate is therefore oleophilic and accepts printing ink, while the non-image area that used to be coated with the coating removed by the developer is desensitized and therefore hydrophilic.

Many different compositions for the photosensitive layer of negative working lithographic printing plate precursors have been described. For example, the use of negative working diazo resins in the photosensitive layer has been long known in this connection.

DE-C-3627585 discloses a process for the production of planographic printing plates by applying a negative working photosensitive mixture comprising a diazo resin onto a substrate. The photosensitive mixture to be applied is characterized in that the solvent comprises 10 to 100 wt.-% 1-methoxy-2-propanol.

In DE-C-3807406, a solvent mixture of at least 10 wt.-% 1-methoxy-2-propanol, 2 to 50 wt.-% methyl lactate, a polar solvent free of amino groups with a boiling point of 50 to 100° C. and a dielectric constant of at least 5.5 at 20° C. and a further solvent is used for such a process.

DE-A-3924812 describes a solvent mixture for light-hardenable compositions. This solvent mixture consists of (a) a mixture of (i) a polar solvent (selected from water and C₁-C₃ alkanol), (ii) a monoalkyl ether or alkyl ether ester of a C₂-C₃ glycol and (iii) a solvent (selected from an aliphatic ketone, an alcanoic acid or hydroxyalcanoic acid alkyl ester and a cyclic ether (each with a boiling point in the range of 60 to 160° C.) and (b) 0.1-8 wt-% of a solvent whose boiling point is higher than that of each of the solvents listed under (a).

DE-A-4212081 discloses a process for the production of negative working offset printing plates wherein diacetone alcohol is used as solvent for the coating.

The use of a solvent mixture comprising (a) at least 2% of a monoether of diethylene glycol and (b) other solvents with a boiling point below 200° C. for negative working mixtures is described in DE-A-3938788.

DE-A-3705342 describes a positive working composition which uses a mixture of methyl ethyl ketone, propylene glycol monomethyl ether and diethylene glycol dimethyl ether as solvent.

EP-A-851 297 and EP-A-851 298 disclose photosensitive compositions for coating rolls. As solvent, a mixture of propylene glycol alkyl ethers and/or propylene glycol diacetate with other solvents or a solvent comprising at most 20 wt.-% propylene glycol and/or dipropylene glycol is used.

The U.S. patent application 2001/0008739 describes positive working photoresist compositions comprising (a) at least one solvent selected from propylene glycol monomethyl ether acetate and propylene glycol monomethyl ether propionate, and (b) at least one solvent selected from propylene glycol monomethyl ether and ethoxyethyl propionate.

It is the object of the present invention to provide a process for the production of negative working photosensitive elements which provides good quality coatings at high coating rates and even results in excellent properties of the radiation-sensitive elements if the solution used for coating has not been freshly prepared prior to the application. Furthermore, the solvents used should be safe with respect to environmental and health concerns, and not involve high costs.

Another object of the invention is to provide a radiation-sensitive mixture which can be used in such a process.

The first object is achieved by a process comprising:
(1) Providing an optionally pretreated substrate,
(2) applying a radiation-sensitive composition onto the substrate by means of a slot coater, wherein the radiation-sensitive composition comprises:
   (a) at least one negative working diazo resin,
   (b) at least one polymer with carboxyl groups soluble or swellable in an alkaline solution,
   (c) a solvent mixture comprising:
      (i) 2 to 9.9 wt.-% 1-methoxy-2-propanol,
      (ii) 20 to 50 wt.-% of at least one ketone with a boiling point below 130° C.,
      (iii) 20 to 60 wt.-% of at least one alkanol with a boiling point below 120° C., and
      (iv) 10 to 30 wt.-% ethyl lactate and
   (d) optionally one or more additives selected from stabilizing acids, colorants, plasticizers, surfactants, thickeners and exposure indicators, and
(3) drying.

A dimensionally stable plate or foil-shaped material is preferably used as a substrate in the production of printing plate precursors. Preferably, a material is used as dimensionally stable plate or foil-shaped material that has already been used as a substrate for printing matters. Examples of such substrates include paper, paper coated with plastic materials (such as polyethylene, polypropylene, polystyrene), a metal plate or foil, such as e.g. aluminum (including aluminum alloys), zinc and copper plates, plastic films made e.g. from cellulose diacetate, cellulose triacetate, cellulose propionate, cellulose acetate, cellulose acetatebutyrate, cellulose nitrate, polyethylene terephthalate, polyethylene, polystyrene, polypropylene, polycarbonate and polyvinyl acetate, and a laminated material made from paper or a plastic film and one of the above-mentioned metals, or a paper/plastic film that has been metallized by vapor deposition. Among these substrates, an aluminum plate or foil is especially preferred since it shows a remarkable degree of dimensional stability, is inexpensive and furthermore exhibits excellent adhesion to the coating. Furthermore, a composite film can be used wherein an aluminum foil has been laminated onto a polyethylene terephthalate film.

A metal substrate, in particular an aluminum substrate, is preferably subjected to a surface treatment, for example roughening by brushing in a dry state or brushing with abrasive suspensions, or electrochemical graining, e.g. by means of a hydrochloric acid electrolyte, and optionally an anodization.

In order to improve the hydrophilic properties of the surface of the metal substrate that has been roughened and optionally anodized in sulfuric acid or phosphoric acid, the metal substrate can be subjected to an aftertreatment with an aqueous solution of sodium silicate, alkali or alkaline earth hexafluorozirconate, polyvinylphosphonic acid or phosphoric acid. Within the framework of the present invention, the term “substrate” also encompasses an optionally pretreated substrate exhibiting, for example, a hydrophilizing layer on its surface.

The details of the above-mentioned substrate pretreatment are known to the person skilled in the art.

The composition to be applied onto the substrate comprises at least one negative working diazo resin, preferably one of the formula (1)

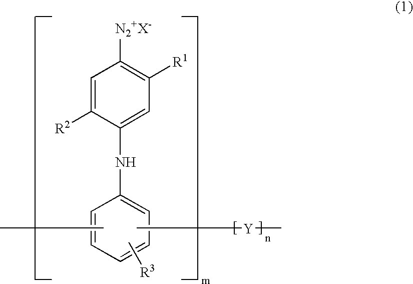

In formula (1), R¹ and R² independently each represent a hydrogen atom, alkyl (preferably C₁-C₁₈, especially preferred C₁-C₁₀) or alkoxy (preferably C₁-C₁₈, especially preferred C₁-C₁₀). Preferably, R¹ is H or —OCH₃, especially preferred —OCH₃; R² is preferably H or —OCH₃, especially preferred H.

R³ is selected from a hydrogen atom, alkyl (preferably C₁-C₁₈, especially preferred C₁-C₁₀), alkoxy (preferably C₁-C₁₈, especially preferred C₁-C₁₀), and the group —COOR, wherein R is alkyl (preferably C₁-C₁₈, especially preferred C₁-C₁₀) or aryl (preferably phenyl). It is preferred that R³ be H—.

X⁻ is an organic or inorganic anion. Examples of suitable anions include dihydrogen phosphate, hexafluorophosphate, hexafluoroantimonate, hexafluoroarsenate, tetrafluoro-borate and aromatic sulfonates such as 4-tolylsulfonate and mesitylenesulfonate.

Y is a spacer group which is introduced into the diazo resin by co-condensation of a monomeric diazo compound with a compound selected from aliphatic aldehydes, aromatic aldehydes, phenol ethers, aromatic thioethers, aromatic hydrocarbons, aromatic heterocycles and organic acid amides. Examples of Y include —CH₂— and —CH₂—C₆H₄—O—C₆H₄—CH₂—.

m/n is 0.5 to 2, preferably 0.9 to 1.1 and especially preferred 1.

Monomeric diazo compounds that can be used in the preparation of the diazo resin include for example 4-diazodiphenylamine, 4′-hydroxy-4-diazodiphenylamine, 4′-methoxy-4-diazodiphenylamine, 4′-ethoxy-4-diazodiphenylamine, 4′-n-propoxy-4-diazodiphenylamine, 4′-i-propoxy-4-diazodiphenylamine, 4′-methyl-4-diazodiphenylamine, 4′-ethyl-4-diazodiphenylamine, 4′-n-propyl-4-diazodiphenylamine, 4′-i-propyl-4-diazodiphenylamine, 4′-n-butyl-4-diazodiphenylamine, 4′-hydroxymethyl-4-diazodiphenylamine, 4′-β-hydroxy-ethyl-4-diazodiphenylamine, 4′-γ-hydroxypropyl-4-diazodiphenylamine, 4′-methoxymethyl-4-diazodiphenylamine, 4′-ethoxymethyl-4-diazodiphenylamine, 4′-β-methoxyethyl-4-diazo-diphenylamine, 4′-β-ethoxyethyl-4-diazodiphenylamine, 4′-carbomethoxy-4-diazodi-phenylamine, 4′-carboxyethoxy-4-diazodiphenylamine, 4′-carboxy-4-diazodiphenylamine, 4-diazo-3-methoxy-diphenylamine, 4-diazo-2-methoxy-diphenylamine, 2′-methoxy-4-diazodiphenylamine, 3-methyl-4-diazodiphenylamine, 3-ethyl-4-diazodiphenylamine, 3′-methyl-4-diazodiphenylamine, 3-ethoxy-4-diazodiphenylamine, 3-hexyloxy-4-diazodi-phenylamine, 3-β-hydroxyethoxy-4-diazodiphenylamine, 2-methoxy-5′-methyl-4-diazodi-phenylamine, 4-diazo-3-methoxy-6-methyldiphenylamine, 3,3′-dimethyl-4-diazodiphenyl-amine, 3′-n-butoxy-4-diazodiphenylamine, 3,4′-dimethoxy-4-diazodiphenylamine, 2′-carboxy-4-diazodiphenylamine, 4-diazodiphenyl-ether, 4′-methoxy-4-diazodiphenyl-ether, 4′-methyl-4-diazodiphenyl-ether, 3,4′-dimethoxy-4-diazodiphenyl-ether, 4′-carboxy-4-diazo-diphenyl-ether, 3,3′-dimethyl-4-diazodiphenyl-ether, 4-diazodiphenylsulfide, 4′-methyl-4-diazodiphenylsulfide and 4′-methyl-2,5-dimethoxy-4-diazodiphenylsulfide, but are not restricted to these compounds.

Preferred reaction partners for the diazo compounds include e.g. formaldehyde, 4,4′-bismethoxy-methyldiphenylether, acetaldehyde, propionaldehyde, butyraldehyde, isobutyr-aldehyde and benzaldehyde, but are not restricted to these compounds. Especially preferred are formaldehyde and 4,4′-bismethoxy-methyldiphenylether. The conditions for the preparation of the diazo resins are well known to the person skilled in the art; reference is made in this connection to U.S. Pat. No. 3,849,392.

Especially preferred diazo resins are those obtained by way of co-condensation of 1 mole 4,4′-bis-methoxymethyldiphenylether and 3-methoxydiphenylamine-4-diazonium salt.

According to the invention, the coating solutions furthermore comprise at least one polymer with carboxyl groups soluble or swellable in an alkaline solution. Polyvinyl acetals with carboxyl groups and in particular a polyvinyl acetal comprising the following structural units A, B, C and D are preferred: 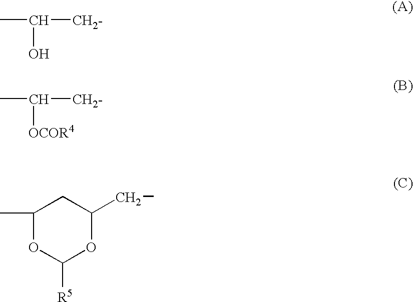
wherein D is at least one unit selected from D-1, D-2, D-3 and D-4: 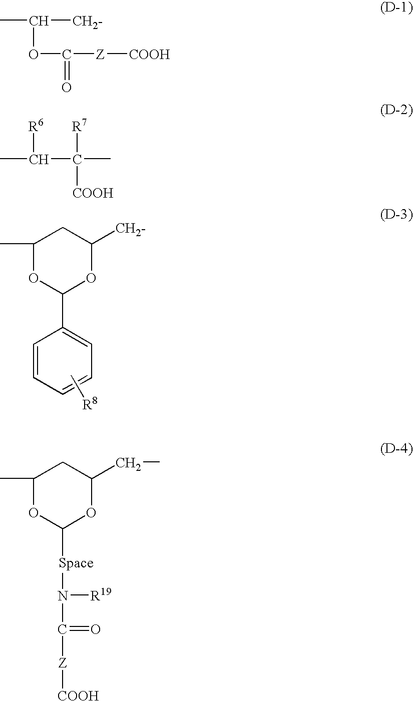
wherein
R⁴ represents H or C₁-C₄ alkyl (preferably H, —CH₃, —CH₂CH₃, especially preferred —CH₃),
R⁵ represents H or C₁-C₁₈ alkyl (preferably —CH₃, —CH₂CH₃, —(CH₂)₂CH₃, especially preferred —CH₃ and —(CH₂)₂CH₃),
R⁶ represents H or C₁-C₄ alkyl (preferably H, —CH₃, —CH₂CH₃, especially preferred H),
R⁷ represents H or C₁-C₄ alkyl (preferably H, —CH₃, —CH₂CH₃, especially preferred H),
R⁸ represents —COOH, —(CH₂)ₐ—COOH, —O—(CH₂)ₐ—COOH, —SO₃H, —PO₃H₂ or —PO₄H₂ (preferably —COOH, —SO₃H, —PO₃H₂, especially preferred —COOH), and
a is an integer from 1 to 8 (preferably 1 to 4, especially preferred 1).
Z is selected from
   —(CR⁹R¹⁰)ₖ— and —CR¹¹═CR¹²—
   wherein k is an integer from 1 to 6, each R⁹ and R¹⁰ is independently selected from a hydrogen atom and C₁-C₆ (preferably C₁-C₄) alkyl (if k>1, not all groups R⁹ have to be the same, nor do all groups R¹⁰ have to be the same), and
R¹¹ and R¹² are independently selected from a hydrogen atom and C₁-C₆ (preferably C₁-C₄) alkyl or R¹¹ and R¹², together with the two carbon atoms to which they are bonded, form an optionally substituted aryl or heteroaryl group.

“Space” indicates an aliphatic, aromatic or araliphatic spacer group, preferably —CH₂—, —CH(CH₃)—, —CH₂—CH₂—CH₂—, 1,2-C₆H₄ and 1,4-C₆H₄—, especially preferred —CH(CH₃)—.

R¹⁹ is a hydrogen atom or an aliphatic, aromatic or araliphatic group, preferably a hydrogen atom or a straight chain or branched alkyl group (for instance C₁-C₁₂) and methyl is especially preferred.

The optionally substituted aryl group can for example be an optionally substituted phenyl or naphthyl group, with an unsubstituted phenyl being preferred.

The optionally substituted heteroaryl group usually comprises 5 or 6 ring atoms, of which one or more (preferably 1 or 2) are heteroatoms selected from sulfur, oxygen and nitrogen atoms. Preferred heteroaryl groups comprise one oxygen atom, one sulfur atom or one to two nitrogen atoms.

Suitable substituents for the aryl and heteroaryl groups are C₁-C₄ alkyl, C₁-C₄ halogenalkyl, cyano groups, C₁-C₄ alkoxy and —COOH. The number of substituents—if present—is usually 1 to 3; however, unsubstituted aryl and heteroaryl groups are preferred.

It is especially preferred that Z be selected from:
—CR¹³R¹⁴—CR¹⁵R¹⁶—; —CR¹⁷═CR¹⁸— 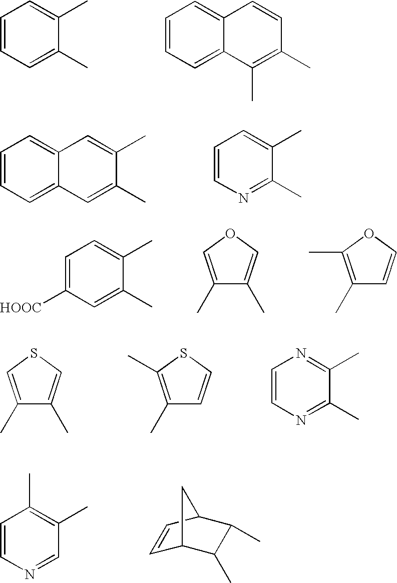
wherein R¹³ to R¹⁸ are each independently selected from a hydrogen atom and C₁-C₆ alkyl. Of the units (D-1), (D-2), (D-3) and (D4), (D-3) and (D4) are especially preferred.

Polyvinyl acetals comprising several different units B and/or C and/or D can also be used in the present invention. The ratio of units A, B, C and D in the polyvinyl acetals of the present invention is not particularly restricted; however, they are preferably present in the following amounts:
Unit A 20 to 70 mole-% (especially preferred 25 to 50 mole-%),
Unit B 0.1 to 25 mole-% (especially preferred 1 to 15 mole-%),
Unit C 10 to 75 mole-% (especially preferred 25 to 65 mole-%) and
Unit D 1 to 25 mole-% (especially preferred 2 to 15 mole-%),
   each based on the total number of monomer units in the acetal polymer.

If several different units B are present, the amount given refers to the total amount of units B. The same applies to units C and D.

The vinyl alcohol/vinyl acetate copolymers that serve as starting materials in the preparation of the acidic polyvinylacetals of the present invention are preferably hydrolyzed to a degree of 70 to 98 mole-% and usually have a weight-average molecular weight M_{w} of 20,000 to 130,000 g/mole. Exactly which copolymer is used as a starting material for the synthesis depends on the desired future application of the radiation-sensitive element. For offset printing plates, polymers with a weight-average molecular weight M_{w} of 35,000 to 130,000 g/mole and a degree of hydrolysis of the vinyl acetate structural unit of 80 to 98 mole-% are preferably used.

It is preferred that the polyvinyl acetals used in the present invention have an acid number of at least 10 mg KOH/g polymer, especially preferred at least 30 mg KOH/g polymer. Preferably, the acid number is not higher than 160 KOH/g polymer, more preferred not higher than 140 KOH/g polymer. The “acid number” indicates the number of mg of KOH necessary for neutralizing 1 g of polymer.

The acidic polyvinyl acetals can be prepared using known methods. Acidic polyvinyl acetals suitable for the present invention and their preparation are described in detail e.g. in U.S. Pat. No. 5,169,897, DE-C-19524851, DE-B-34 04 366 and DE-A-100 11 096.

The coating solution used in the present invention can optionally also comprise one or more additives selected from stabilizing acids (e.g. phosphoric acid, phosphonic acid, diphosphoric acid, oxalic acid, boric acid, p-toluolenesulfonic acid, benzosulfonic acid, p-hydroxybenzosulfonic acid, 2-methoxy-4-hydroxy-5-benzoylbenzosulfonic acid, maleic acid, citric acid, tartaric acid, dipicolinic acid, 5-nitro-naphthalene-1-phosphoric acid, 4-chlorophenoxymethylphosphonic acid, phenylmethylpyrazolonesulfonate sodium salt, 2-phosphonobutane-1,2,4-tricarboxylic acid, 1-phosphonoethane-1,2,2-tricarboxylic acid and 1-hydroxyethane-1,1-disulfonic acid and mixtures thereof), surfactants (e.g. anionic, cationic or neutral tensides, such as siloxane-containing polymers, fluorine-containing polymers and polymers with ethylene oxide and/or propylene oxide groups), thickeners (e.g. carboxymethyl cellulose), plasticizers (e.g. dibutyl phthalate, triaryl phosphate, dioctyl phthalate, didodecyl phthalate, dibutyl sebacate, triacetyl glycerin and mixtures thereof), exposure indicators (e.g. 4-phenylazodiphenylamine) and contrast dyes and pigments for coloring the layer (e.g. rhodamine dyes, crystal violet, ethyl violet, azo pigments and dyes, carbon black, titanium dioxide, cyanine dyes, anthraquinone pigments, and phthalocyanine dyes and pigments).

The amount of stabilizing acids is preferably 0 to 3 wt.-%, based on the dry layer weight, especially preferred 0.2 to 3 wt.-%. The surfactants can be used in an amount of e.g. 0 to 10 wt.-%, preferably 0.05 to 1 wt.-%. Thickeners are commonly used in an amount of e.g. 0 to 2 wt.-%, preferably 0.1 to 0.5 wt.-%. Plasticizers can e.g. be used in an amount of 0 to 10 wt.-%, preferably 0.25 to 5 wt.-%. The contrast dyes and pigments can be used in an amount of e.g. 0 to 20 wt.-%, especially preferred 0.5 to 15 wt.-%. The amount of exposure indicators is preferably 0 to 5 wt.-%, especially preferred 0.3 to 2 wt.-%.

Furthermore, inorganic and/or organic particles can be present which support the application of the vacuum during the exposure of the lithographic printing plate precursor. Suitable particles include for example aluminum oxide, titanium dioxide, silicon dioxide or organic particles consisting of polyethylene, polypropylene, polystyrene or polyamide; such particles as well as suitable particle sizes are described e.g. in EP 161 592, EP 527 369 and U.S. Pat. No. 4,599,299. They can amount to 0 to 20 wt.-% of the layer, especially preferred 0 to 10 wt.-%.

The solution to be applied preferably comprises 0.1 to 5 wt.-% of the diazo resin(s), especially preferred 0.5 to 3 wt.-%. The total amount of additives is preferably 0 t 10 wt.-%, especially preferred 0.1 to 5 wt.-%.

It is essential for the process according to the present invention that the diazo resin, the polymer with carboxyl groups soluble or swellable in alkaline solutions and optional additives be dissolved in a solvent mixture comprising
(i) 2 to 9.9 wt.-% 1-methoxy-2-propanol,
(ii) 20 to 50 wt.-% of at least one ketone with a boiling point below 130° C.,
(iii) 20 to 60 wt.-% of at least one alkanol with a boiling point below 120° C. and
(iv) 10 to 30 wt.-% ethyl lactate
   wherein the weight percentages given refer to the solvent mixture.

The boiling points indicated above are boiling points determined under atmospheric pressure.

The amount of ketone (ii) is preferably 25 to 40 wt.-%. If a mixture of ketones is used wherein the boiling point of each individual ketone is below 130° C., the amount given for the ketones of course refers to the total amount of all ketones used. Examples of suitable ketones include acetone, methyl ethyl ketone, diethyl ketone, methyl isopropyl ketone, methyl n-propyl ketone, mesityloxide, methyl isobutyl ketone and methyl n-butyl ketone. Acetone and methyl ethyl ketone are preferred.

The amount of the at least one alkanol (iii) is preferably 30 to 50 wt.-%. If a mixture of alkanols is used wherein the boiling point of each individual alkanol is below 120° C., the amount given for the alkanols of course refers to the total amount of all alkanols used.

Within the framework of the present invention, alkanols are straight-chain or branched monovalent alcohols R—OH, with R being an unsubstituted alkyl group.

Examples of suitable alkanols include methanol, ethanol, n-propanol, isopropanol, n-butanol, isobutanol, sec-butanol, tert-butanol and neopentyl alcohol. Especially preferred are methanol and ethanol.

The amount of ethyl lactate is preferably 10 to 25 wt.-%. The amount of 1-methoxy-2-propanols is preferably 5 to 9.9 wt.-%.

The concentration of the prepared solution, i.e. how many grams of solids (diazo resins, carboxy polymers, additives) are dissolved in 100 g of solvent mixture, is not particularly restricted, however, in view of the application by means of a slot coater it is preferably 1 to 10 wt.-%, especially preferred 2 to 8 wt.-%; this results in a wet coating with 100 to 10 g/m² or 50 to 12.5 g/m².

The dry layer weight of the radiation-sensitive layer is preferably 0.1 to 3 g/m², especially preferred 0.3 to 1.5 g/m².

The radiation-sensitive elements of the present invention can for example be printing plate precursors (in particular precursors of lithographic printing plates), circuit boards for integrated circuits or photomasks.

In few cases, the additional application of a water-soluble overcoat onto the radiation-sensitive layer can be advantageous. The polymers suitable for such an overcoat include, inter alia, polyvinyl alcohol, polyvinyl alcohol/polyvinyl acetate copolymers, polyvinyl pyrrolidone, polyvinyl pyrrolidone/polyvinyl acetate copolymers and gelatin. The layer weight of the overcoat can e.g. be 0.1 to 4 g/m², preferably 0.3 to 2 g/m². However, the printing plate precursors according to the present invention show excellent properties even without an overcoat. The overcoat can also comprise matting agents (i.e. organic or inorganic particles with a particle size of 2 to 20 μm) which facilitate the planar positioning of the film during contact exposure. An alternative would be to spray the radiation-sensitive layer of the plate with an aqueous polymer solution, which would lead to a “formation of knobs” to promote the vacuum.

The thus produced printing plate precursors are exposed with UV radiation in a manner known to the person skilled in the art and subsequently developed with a commercially available aqueous alkaline developer. The developed plates can be treated with a preservative (“gumming”) using a common method. The preservatives are aqueous solutions of hydrophilic polymers, wetting agents and other additives. Optionally, after image-wise exposure (i.e. prior to developing), a heat treatment at 50 to 180° C., preferably 90 to 150° C., can be carried out.

For certain applications, it is furthermore advantageous to increase the mechanical strength of the printing layers by subjecting them to a heat treatment (what is referred as “baking”) and/or overall exposure (e.g. to UV light). For this purpose, prior to the treatment, the developed plate is treated with a solution that protects the non-image areas such that the heat treatment does hot cause these areas to accept ink. A solution suitable for this purpose is e.g. described in U.S. Pat. No. 4,355,096. Baking usually takes place at temperatures in the range of 150 to 250° C. However, printing plates prepared from printing plate precursors according to the present invention show excellent properties even without having been subjected to a heat treatment. When both baking and overall exposure are carried out, the two treatment steps can be performed simultaneously or one after the other.

The invention will be explained in more detail in the following examples.

### EXAMPLES 1 TO 3 AND COMPARATIVE EXAMPLES 1 TO 5

Coating solutions were prepared in a 300 1 vessel, wherein the components listed in Table 1 were added to a solvent mixture as described in Table 2.

TABLE 1

| | | |
|---|---|---|
| 4.32 | kg | binder A¹⁾, B²⁾ or C³⁾ |
| 3.94 | kg | polycondensation product from 1 mole 3-methoxydi- |
| | | phenylamine-4-diazonium sulfate and 1 mole 4,4′- |
| | | bis-methoxymethyldiphenylether precipitated as |
| | | mesitylene sulfonate |
| 1.52 | kg | Renol blue B2G-HW ® (copper phthalocyanine pigment |
| | | dispersed in polyvinylbutyral; available from |
| | | HOECHST |
| 0.05 | kg | 4-phenyl-azo-diphenylamine |
| 0.07 | kg | phosphoric acid |
| 200 | kg | solvent mixture (see Table 2) |

¹⁾Binder A: corresponds to Preparation Example 6 of EP-B-752 430 (polyvinyl acetal with the following units: vinyl alcohol; vinyl acetate; acetal groups derived from acetaldehyde; acetal groups derived from butyraldehyde; acetal derived from the reaction product of maleic acid anhydride and 2-(N-methylamino)-acetaldehyde-dimethylacetal)
²⁾Binder B: polyvinyl acetal binder comprising 39.9 mole-% vinyl alcohol; 1.2 mole-% vinyl acetate; 15.4 mole-% acetal groups derived from acetaldehyde; 36.1 mole-% acetal groups derived from butyraldehyde; and 7.4 mole-% acetal groups derived from 4-formylbenzoic acid
³⁾Binder C: corresponds to Example 1 of EP-A-152 819 (polyvinyl acetal with the following units: vinyl alcohol; vinyl acetate; acetal derived from butyraldehyde; and butyral reacted with maleic acid anhydride)

TABLE 2

| | | Solvent mixture¹⁾ | | | |
|---|---|---|---|---|---|
| | Binder | [wt.-%]²⁾ | | Results | |
| Example 1 | A | Dow PM | 5.9% | Photo speed: | step 3 solid, step 8 free |
| | | MEK | 34.6% | Length of run: | >100,000 |
| | | MeOH | 39.8% | Appearance of the coating: | very good |
| | | EL | 19.7% | Developability of the plate after | after 48 hours no decrease in |
| | | | | storage of the coating solution: | developability was observed |
| Example 2 | B | Dow PM | 5.9% | Photo speed: | step 4 solid, step 8 free |
| | | MEK | 34.6% | Length of run: | >100,000 |
| | | MeOH | 39.8% | Appearance of the coating: | very good |
| | | EL | 19.7% | Developability of the plate after | after 48 hours no decrease |
| | | | | storage of the coating solution: | in developability was observed |
| Example 3 | C | Dow PM | 5.9% | Photo speed: | step 4 solid, step 8 free |
| | | MEK | 34.6% | Length of run: | >100,000 |
| | | MeOH | 39.8% | Appearance of the coating: | very good |
| | | EL | 19.7% | Developability of the plate after | after 48 hours no decrease in |
| | | | | storage of the coating solution: | developability was observed |
| Comparative | B | Dow PM | 5.9% | Photo speed: | step 4 solid, step 8 free |
| Example 1 | | MEK | 34.6% | Length of run: | 70,000 |
| (DE 3807406) | | MeOH | 39.8% | Appearance of the coating: | very good |
| | | ML | 19.7% | Developability of the plate after | after the solution was stored for |
| | | | | storage of the coating solution: | 24 hours, a decrease in developability |
| | | | | | was observed |
| Comparative | B | Dow PM | 50.0% | Photo speed: | step 3 solid, step 7 free |
| Example 2 | | MEK | 20.0% | Length of run: | 50,000 |
| (DE 3807406) | | MeOH | 20.0% | Appearance of the coating: | insufficient |
| | | ML | 10.0% | Developability of the plate after | after the solution was stored for |
| | | | | storage of the coating solution: | 24 hours, a decrease in developability |
| | | | | | was observed |
| Comparative | B | Dow PM | 40.0% | Photo speed: | step 2 solid, step 7 free |
| Example 3 | | MEK | 30.0% | Length of run: | 40,000 |
| (DE 3924812) | | MeOH | 29.5% | Appearance of the coating: | acceptable |
| | | PC | 0.5% | Developability of the plate after | after 48 hours no decrease in |
| | | | | storage of the coating solution: | developability was observed |
| Comparative | B | DEGM | 48.0% | Photo speed: | step 2 solid, step 6 free |
| Example 4 | | THF | 52.0% | Length of run: | 30,000 |
| (DE 3938788) | | | | Appearance of the coating: | insufficient |
| | | | | Developability of the plate after | after 48 hours no decrease in |
| | | | | storage of the coating solution: | developability was observed |

| | | | | |
|---|---|---|---|---|
| Comparative | B | DAA | 100% | not all components were dissolved and defects in the coating were observed |
| Example 5 | | | | |
| (DE 4212081) | | | | |

¹⁾MeOH = methanol; Dow PM = 1-methoxy-2-propanol; MEK = methyl ethyl ketone; EL = ethyl lactate; ML = methyl lactate; PC = propylene carbonate; DEGM = diethyleneglycol monomethyl ether; DAA = diacetone alcohol
²⁾The amount indicated for the individual solvents was calculated based on the total weight of all solvents in a mixture.

After filtration, the coating solution was applied onto an electrochemically roughened and anodized aluminum substrate (oxide weight of the substrate: 3.3 g/m²; average roughness: about 0.65 μm; the anodized substrate had been subjected to an aftertreatment with an aqueous solution of polyvinylphosphonic acid). A slot coater was used for coating and the coating was dried in a continuous furnace with 5 drying zones with the following temperatures: Zone 1=50° C., zone 2=50° C., zone 3=70° C., zone 4=80° C. and zone 5=100° C. The coated substrate was transported through the oven at a band speed of 45 m/min and the resulting dry layer weight of the photosensitive coating was about 1 g/m². The coated band was cut into plates of 380×610 mm² and used for further evaluations.

The outward appearance of the obtained plate coatings (what is referred to as “cosmetics”) can be inferred from Table 2; a good appearance, i.e. an even coating, is referred to as good cosmetics.

The plates were exposed with a metal halogenide lamp (MH burner, available from the company W. Sack) with 300 mJ/cm² using a silver film halftone step wedge having a tonal range of 0.15 to 1.95, wherein the density increments amounted to 0.15.

The exposed printing plate precursor was treated with a developer solution comprising the following components:
3.4 parts by weight REWOPOL® NLS 28
1.8 parts by weight 2-phenoxy ethanol
1.1 parts by weight diethanol amine
1.0 parts by weight TEXAPON® 842
0.6 parts by weight NEKA® Paste
0.2 parts by weight 4-toluene sulfonic acid
91.9 parts by weight water.

Developing was carried out by immersing the exposed printing plate precursors in the developer solution for 30 seconds and subsequently rubbing the developer solution on the surface for 30 seconds using a tampon. Then the entire plate was rinsed with water. After this treatment, the exposed areas of the coating remained on the plate while the unexposed areas were removed. The number of solid steps and the number of the first free step in the gray scale copied onto the plate were used for the assessment of the photosensitivity of the plate. The results are shown in Table 2.

For assessing the number of obtainable copies, the lithographic printing plate precursor was prepared, exposed, developed and rinsed, rubbed with an aqueous solution of 0.5% phosphoric acid and 6% gum arabic and then used in a sheet-fed offset printing machine under normal printing conditions. The number of copies obtained until first signs of wear were observed in the filled-out areas of the plate was determined to be the print run. The results are shown in Table 2.

For evaluating the storage stability of the coating solutions and the effects on printing plate precursors produced therefrom, printing plate precursor were prepared with a freshly prepared coating solution on the one hand and a 24-hour-old and 48-hour-old coating solution on the other hand. Each of these printing plate precursors were developed without first being exposed. The results can be inferred from Table 2.

A comparison of Example 2 and Comparative Example 1 as well as Comparative Example 2 clearly shows that by using ethyl lactate instead of methyl lactate, the obtained print run can be increased significantly and that furthermore the storage stability of the coating solution and the resulting developability of the plate are improved.

1-17. (canceled)

18. A process for the production of a negative working radiation-sensitive element comprising:
(1) providing an optionally pretreated substrate,
(2) applying a radiation-sensitive composition onto the substrate by means of a slot coater, wherein the radiation-sensitive composition comprises:
(a) at least one negative working diazo resin,
(b) at least one polymer with carboxyl groups soluble or swellable in an alkaline solution,
(c) a solvent mixture comprising:
(i) 2 to 9.9 wt.-% 1-methoxy-2-propanol,
(ii) 20 to 50 wt.-% of at least one ketone with a boiling point below 130° C.,
(iii) 20 to 60 wt.-% of at least one alkanol with a boiling point below 120° C.,
(iv) 10 to 30 wt.-% ethyl lactate; and
(d) optionally one or more additives comprising stabilizing acids, colorants, plasticizers, surfactants, thickeners or exposure indicators; and
(3) drying.

19. The process according to claim 18, wherein the negative working diazo resin is a diazo resin of formula (1): 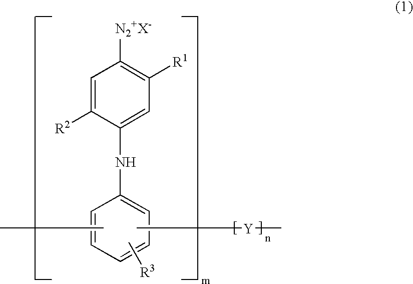
wherein R¹ and R² are each independently a hydrogen atom, alkyl or alkoxy,
R³ is a hydrogen atom, alkyl, alkoxy or —COOR,
R is alkyl,
X⁻ is an inorganic or organic anion,
Y is a spacer group which is introduced into the diazo resin by co-condensation of a monomeric diazo compound with a compound comprising aliphatic aldehydes, aromatic aldehydes, phenol ethers, aromatic thioethers, aromatic hydrocarbons, aromatic heterocycles or organic acid amides, and
m/n is 0.5 to 2.

20. The process according to claim 18, wherein the polymer with carboxyl groups soluble or swellable in an alkaline solution is a polyvinyl acetal copolymer with carboxyl groups.

21. The process according to claim 18, wherein the ketone of 2(c)(ii) is methyl ethyl ketone.

22. The process according to claim 18, wherein the alkanol of 2(c)(iii) is methanol.

23. The process according to claim 18, wherein the substrate is an aluminum plate or foil, which prior to coating is subjected to at least one treatment comprising graining, anodizing or hydrophilizing.

24. The process according to claim 18, wherein the solids content of the radiation-sensitive composition is 1 to 10 wt.-%.

25. The process according to claim 18, wherein the substrate is web coated at a rate of 10 to 120 m/min.

26. A radiation-sensitive composition comprising:
(a) at least one negative working diazo resin,
(b) at least one polymer with carboxyl groups soluble or swellable in an alkaline solution,
(c) a solvent mixture comprising:
(i) 2 to 9.9 wt.-% 1-methoxy-2-propanol,
(ii) 20 to 50 wt.-% of at least one ketone with a boiling point below 130° C.,
(iii) 20 to 60 wt.-% of at least one alkanol with a boiling point below 120° C.,
(iv) 10 to 30 wt.-% ethyl lactate; and
(d) optionally one or more additives comprising stabilizing acids, colorants, plasticizers, surfactants, thickeners or exposure indicators.

27. The radiation-sensitive composition according to claim 26, wherein the ketone of (c)(ii) is methyl ethyl ketone.

28. The radiation-sensitive composition according to claim 26, wherein the alkanol of (c)(iii) is methanol.

29. The radiation-sensitive composition according to claim 26, wherein the negative working diazo resin is a diazo resin of formula (1) 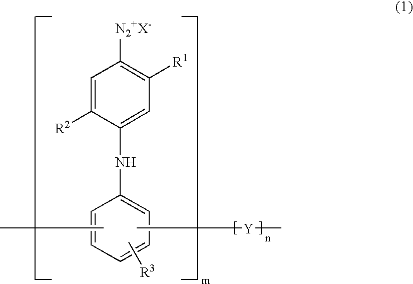
wherein R¹ and R² are each independently a hydrogen atom, alkyl or alkoxy,
R³ is a hydrogen atom, alkyl, alkoxy or —COOR,
R is alkyl,
X⁻ is an inorganic or organic anion,
Y is a spacer group which is introduced into the diazo resin by co-condensation of a monomeric diazo compound with a compound comprising aliphatic aldehydes, aromatic aldehydes, phenol ethers, aromatic thioethers, aromatic hydrocarbons, aromatic heterocycles or organic acid amides, and
m/n is 0.5 to 2.

30. The radiation-sensitive composition according to claim 26, wherein the polymer with carboxyl groups soluble or swellable in an alkaline solution is a polyvinyl acetal copolymer.

31. The radiation-sensitive composition according to claim 26, having a solid content of 1 to 10 wt.-%.

32. A radiation-sensitive element produced by a process according to claim 18.

33. A solvent mixture for producing a radiation-sensitive element comprising:
(i) 2 to 9.9 wt.-% 1-methoxy-2-propanol,
(ii) 20 to 50 wt.-% of at least one ketone with a boiling point below 130° C.,
(iii) 20 to 60 wt.-% of at least one alkanol with a boiling point below 120° C., and
(iv) 10 to 30 wt.-% ethyl lactate.
